(19) United States
(12) Patent Application Publication
(10) Pub. No.: US 2004/0234693 A1
(43) Pub. Date: Nov. 25, 2004

(54) Procedure for screeding concrete walls using two thin walled 3/4 inch conduit linarly placed three feet from the floor and ceiling as screed guide after shotcrete concrete emplacement

(76) Inventor: Earl Raymond Littleton, Pearland, TX (US)

Correspondence Address: EARL LITTLETON, 1920 O'DAY RD., PEARLAND, TX, 77581, US

(21) Appl. No.: 10/443,718

(22) Filed: May 23, 2003

(51) Int. Cl. B05D 3/00; B05D 3/12

(52) U.S. Cl. 427/299; 427/355

(57) ABSTRACT

The usefulness of placing two guide tubes on the wall to be screeded is that it turns a high skilled process (free hand depth management of wall grout) into a very unskilled process: Sawing concrete across two parallel equal level guides.

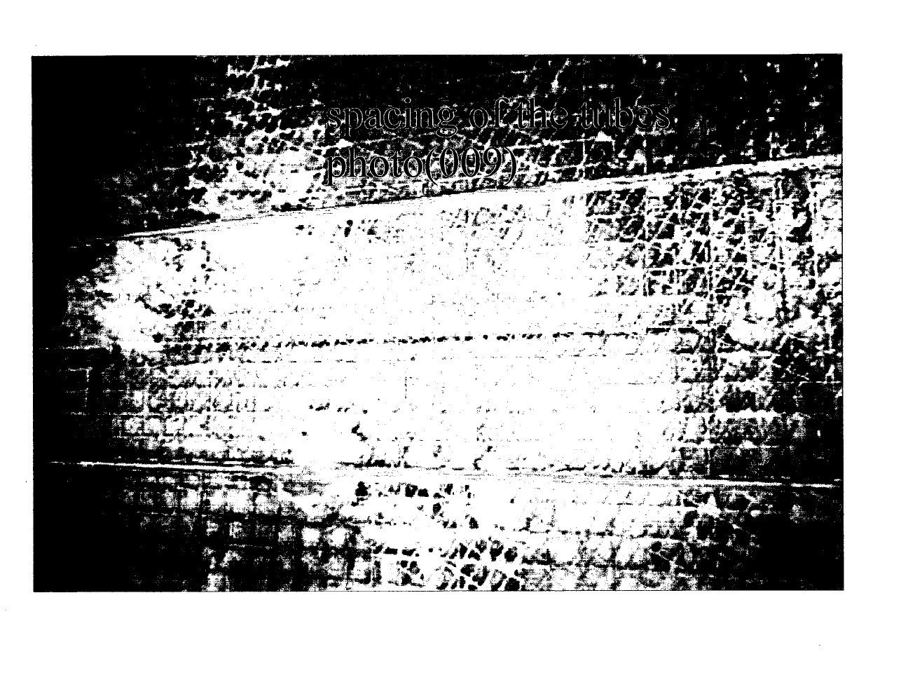

### CROSS REFERENCE TO RELATED APPLICATIONS

Non-Applicable

### STATEMENT REGARDING FEDERALLY SPONSORED RESEARCH OR DEVELOPMENT

Non-Applicable

### BACKGROUND OF THE INVENTION

Screeding the walls after shooting the shotcrete is a very costly high skilled procedure. Low cost houses simply cannot be built with 3-d panels in the United States like they are in Mexico, for example. Labor costs in the United States would force the price out of the reach of retired Americans living on Social Security. Even with very dedicated and enthusiastic young volunteers, the house could not be built. Skilled hand trowel labor or screeding takes years of experience to develop and commands a high salary.

### BRIEF SUMMARY OF THE INVENTION

The general idea of this invention is cost reduction. It is very easy to hire a skilled worker to screed the walls but it is very costly, this invention cuts the cost and allows unskilled workers to perform the same procedure.

### DETAILED DESCRIPTION OF THE INVENTION

Before spraying concrete ¾ inch thick on the walls we must first attach two ¾ inch galvanized, thin walled, electric conduit tubes to the walls. We first wire two conduit tubes running horizontally to the wire mesh using concrete tie wires One tube will be three feet from the ceiling and the other tube three feet from the floor. That is to say, on each eight-foot wall, these tubes are tied 3 feet from the top and 3 foot from the bottom of the wall, running horizontally around each room and the outside walls. The tie wires are painted with anti-rust chemical you can buy at your local hardware. While, the grout is green (partly cured) the grout is smoothed over the tubes. This seems like a labor-intensive non-necessity but the low skill placement of these tubes makes the concrete screeding into a low skill low cost job.

Shooting the concrete on the walls goes really fast, spaying on the concrete to the level of the conduit tube. You come back after spraying the walls; and while the concrete is still green, you screed with a metal tool that is around 6 feet long. The conduct tubes act as a level and guide and are left in the walls. (See photo009)

1. What I claim as my invention is a procedure for screeding concrete walls using two thin walled % inch conduit linearly placed three feet from the floor and ceiling as screed guide after shotcrete emplacement
